(19) United States
(12) Patent Application Publication
(10) Pub. No.: US 2007/0274209 A1
(43) Pub. Date: Nov. 29, 2007

(54) Prioritizing data in a wireless transmission

(76) Inventors: Steven J. Aarnio, Forest Grove, OR (US); David Putzolu, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/441,580

(22) Filed: May 26, 2006

(51) Int. Cl. H04L 12/26; H04J 3/16

(52) U.S. Cl. 370/229; 370/470

(57) ABSTRACT

Various embodiments of the invention may organize prioritized data segments that are to be included in the same transmission, such that higher priority segments are sent earlier in the transmission. If a data error occurs during the transmission that renders the remainder of the transmission unusable, the higher priority segments may have already been received. Such prioritization may be especially helpful when the segments are allowed to have variable lengths, and each segment contains a field specifying its length.

### BACKGROUND

In some types of wireless communications protocol, multiple segments of data may be contained within a continuous transmission, and each of those segments may have a variable length that is specified by a field within the segment. For example, in the protocols defined in IEEE standard 802.16, multiple Protocol Data Units (PDUs) may be transmitted sequentially in a single burst transmission, with each PDU containing a length field that defines its length (e.g., in bytes), so that the receiving device will know where the current PDU ends and the next PDU starts. However, this technique may present some problems if part of the data is corrupted or otherwise received incorrectly, which is common in wireless communications. For example, if the length field is not received correctly, or its integrity is questionable, the receiving device may not be able to tell where the current PDU ends and the next PDU begins, and therefore the current PDU and all remaining PDUs in the transmission may be lost. In some cases, incorrect reception of other fields may create similar problems, resulting in loss of the remaining PDUs. Although the lost PDUs may be retransmitted at a later time, this solution may be inadequate in time-critical communications.

### BRIEF DESCRIPTION OF THE DRAWINGS

Some embodiments of the invention may be better understood by referring to the following description accompanying drawings that are used to illustrate embodiments of the invention. In the drawings:

FIG. 1 shows a flow diagram of a method, according to an embodiment of the invention.

FIG. 2 shows a prioritized buffer of data segments, according to an embodiment of the invention.

FIG. 3 shows a format for a transmission, according to an embodiment of the invention.

FIG. 4 shows a diagram of a communications system, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “wireless” may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The term “mobile wireless device” may be used to describe a wireless device that may be moved while it is communicating.

As used in the claims, unless otherwise specified the use of the ordinal adjectives “first”, “second”, “third”, etc., to describe a common object, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

Various embodiments of the invention may prioritize the data segments that are to be transmitted in a single burst (sometimes called a transmission region), placing higher priority segments ahead of lower priority segments in the transmission. In this manner, if a later portion of the transmission is lost because it cannot be reliably received, the higher priority segments may have already been correctly received before the problem occurred because they were placed earlier in the transmission. This technique may be especially helpful with protocols in which the data segments have a variable length, and each data segment contains a value indicating its length. With such protocols, a loss of the length indicator in any segment may cause the loss of all subsequent segments in the transmission.

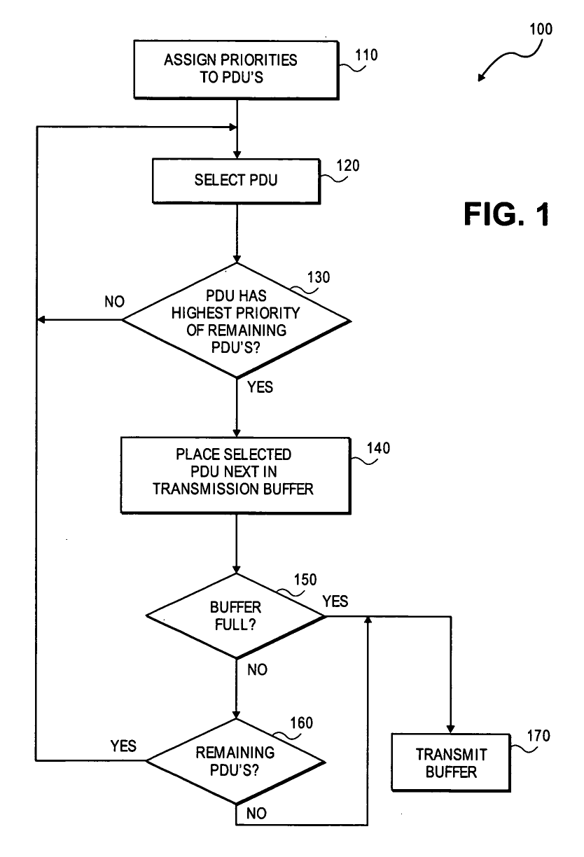

FIG. 1 shows a flow diagram of a method, according to an embodiment of the invention. In the flow diagram 100, the method may begin at 110 by assigning priorities to the data segments that are to be combined and transmitted sequentially in a single burst transmission. The burst transmission with multiple data segments may also sometimes be called a transmission region, but some embodiments of the invention may not be limited to transmissions that are described with that term. Some embodiments may conform to the requirements of an industry standard (e.g., IEEE 802.16), but other embodiments may not be limited in this manner. In some embodiments, the assignment of priorities may be performed in the device that performs the transmission, but other embodiments may use other techniques (e.g., the data segments may have previously been assigned priority, or certain types of data segments may automatically have certain priority, etc.). In some embodiments, each data segment may have an assigned priority that is unique within the group of data segments to be transmitted in that particular transmission, so that each data segment has a specifically defined place in the order of transmission. In other embodiments, priority may be assigned to types of data segments, and all data segments of a certain type may have the same priority level, so that order of transmission within the same priority level may not be controlled.

The criteria used to determine priority may be based on various factors. In some embodiments, the factors may include user application considerations. For example, streaming video and/or Voice over Internet Protocol (VoIP) may have a high priority, since a delay in receiving a data segment may interrupt a smooth presentation of the video or audio information. Conversely, backing up data remotely may have low priority, since some delay in receiving portions of the data are not usually considered important. In some other embodiments, priority may be based on network operational considerations. For example, some handshaking protocols are time critical—a response to a query must be received within a certain time period or the connection between the two devices may deteriorate or even be terminated. Conversely, reporting long-term downtime percentages for a wide-area network may have relatively low priority, since any reaction to that information will probably involve long human delays. Some embodiments may combine various types of factors, such as combining user application and/or network operation and/or other factors.

The process of ordering the data segments by their priority level may be performed in various ways, one of which begins at 120 by selecting a data segment that is to be transmitted. The data segments may take various forms, and may be described in various ways. A data segment called a protocol data unit (PDU) is used here for illustrative purposes, but other types of data segments may alternatively be used. The selected PDU may be examined at 130 to determine if its priority level is at least as high as any of the PDUs that remain to be selected for this particular transmission. If not, another PDU may be selected and similarly examined. If yes, the selected PDU may be placed into the next location in a transmission buffer at 140. As determined at 150 and 160, if the transmission buffer is full, or if the transmission buffer is not full but there are no more PDUs to select for this transmission, then the PDUs in the transmission buffer may be transmitted at 170. If the transmission buffer is not full and there are more PDUs to select for this transmission, then the process may return to 120 to select another PDU, and the cycle may continue until the PDUs are transmitted. Once the buffer is transmitted (or in some embodiments just flagged for transmission), the process of flow diagram 100 may be repeated whenever there are more PDUs to be transmitted.

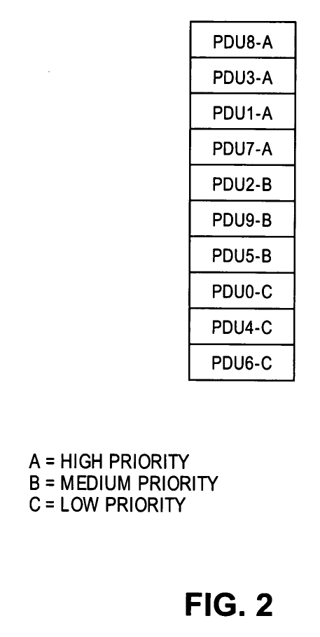

FIG. 2 shows a prioritized buffer of data segments, according to an embodiment of the invention. In the illustrated example ten PDUs, labeled PDU0 through PDU9, have each been assigned to one of three priority groups—A for a high priority group, B for a medium priority group, and C for a low priority group. Based on their priority assignments, the ten PDUs have then been arranged in priority order in the buffer. The high priority PDUs (A) are shown at the top of the buffer, and would be transmitted before the medium priority PDUs (B), which would in turn be transmitted before the low priority PDUs (C) at the bottom of the buffer. Order within a priority group (e.g., which of the high priority PDUs should be transmitted first) may be based on any feasible criteria (e.g., random order, sub-priority categories, length, etc.). The manner of choosing which PDUs are candidates for this particular buffer may also be based on any feasible criteria.

Although this example illustrates the use of group priorities, other embodiments may assign a different priority level for each PDU. Still other embodiments may use a combination of group priorities and individual priorities. Although this example only shows the PDUs, the actual transmission may include other fields, such as but not limited to any or all of: a preamble, a header, a data integrity check such as a cyclic redundancy check (CRC) value, etc. The transmission buffer may include any or all of such additional fields, or they may be inserted dynamically before actual transmission.

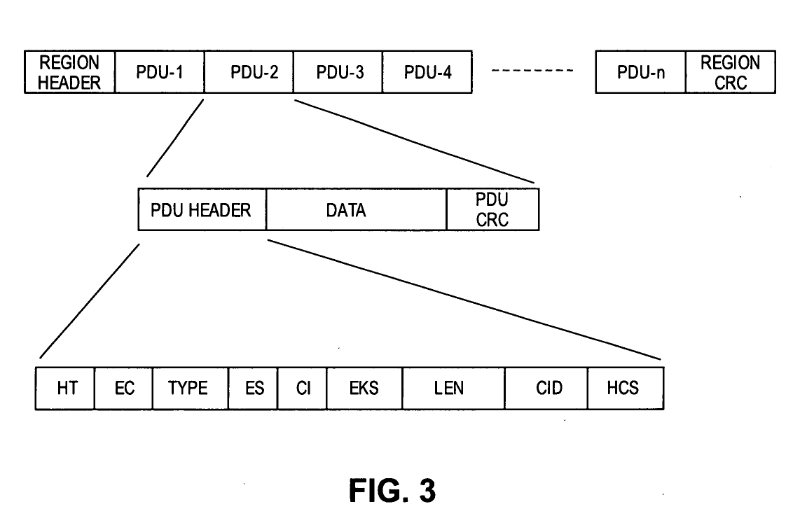

FIG. 3 shows a format for a transmission, according to an embodiment of the invention. At the top of FIG. 3 is shown an example of a format for a transmission containing multiple data segments (labeled as PDUs, although other embodiments may use other types of data segments). In some embodiments the transmission may be labeled as a frame, although other embodiments may not use that terminology. In the example, the multiple PDUs are shown as defining a transmission region, although other embodiments may not use that terminology. Accordingly, the example shows the PDUs preceded by a region header, which may contain information defining various aspects of the transmission. The example further shows a cyclic redundancy check (CRC) value for the region to be used for detecting (and in some embodiments correcting) errors in the received transmission. Other embodiments may eliminate either or both of the header and the CRC. The example shows a quantity ‘n’ of PDUs being transmitted sequentially, where n may be any feasible quantity. In some embodiments the PDUs may be arranged in order of priority (either individually or in groups) with the highest priority PDUs at the beginning and the lowest priority PDUs at the end. In some embodiments the transmission may contain other fields not shown. In some embodiments the transmission may be part of a larger transmission which may contain other portions that may include, but are not limited to, other transmission regions.

Each PDU may have a defined format, one embodiment of which is shown as including a PDU header which may contain information defining various aspects of the PDU. The data field may contain any feasible information. In some embodiments the data field may contain headers and/or data fields and/or CRC's for units of information smaller that a PDU or its equivalent. The end of the PDU may include a value to check the data integrity of the received PDU, such as a PDU CRC. In some embodiments the PDU may include other fields and/or details not shown.

Each PDU header may have a defined format, one embodiment of which is shown at the bottom of FIG. 3. Although other embodiments may have different formats and/or field definitions, the illustrated example may contain the following fields:

HT—Header type. In some embodiments this may distinguish between a generic informational header, and a signaling header (which may not be followed by a data field).

EC—Encryption control. In some embodiments this may indicate if the subsequent data is encrypted.

Type—The type of payload in the data field. In some embodiments this may indicate the format used within the data field, including the presence of sub-headers.

ES—Extended subheader. In some embodiments, this may indicate additional header information.

CI—CRC indicator. In some embodiments this may indicate whether a CRC or other data integrity value is appended to the end of the data (e.g., in some embodiments there may not be a PDU CRC field).

EKS—Encryption key sequence. In some embodiments this may contain one or more keys associated with encryption/decryption of the data.

LEN—Length of the PDU. In some embodiments this field may indicate the length of the PDU in standards units (e.g., in bytes). The value contained in this field may be used by the receiving device to determine where in the transmission that the current PDU ends and the subsequent PDU begins. In some embodiments, knowing this information may be critical to correctly receiving the remainder of the transmission.

CID—Connection identifier. In some embodiments this field may identify the connection between the transmitting and receiving parties for this PDU

HCS—Header check sequence. In some embodiments this field may serve as a data integrity check (similar to a CRC) just for this header. In some embodiments a failure of the data integrity check of the header (e.g., based on the HCS) may cause the accuracy of the entire header to be questionable, which may in turn cause the value in the length field to be questionable, which may in turn cause the remaining PDUs in the transmission to be unparsable. The effect of a failed HCS may vary, depending on whether other factors permit the integrity of the length field to be verified.

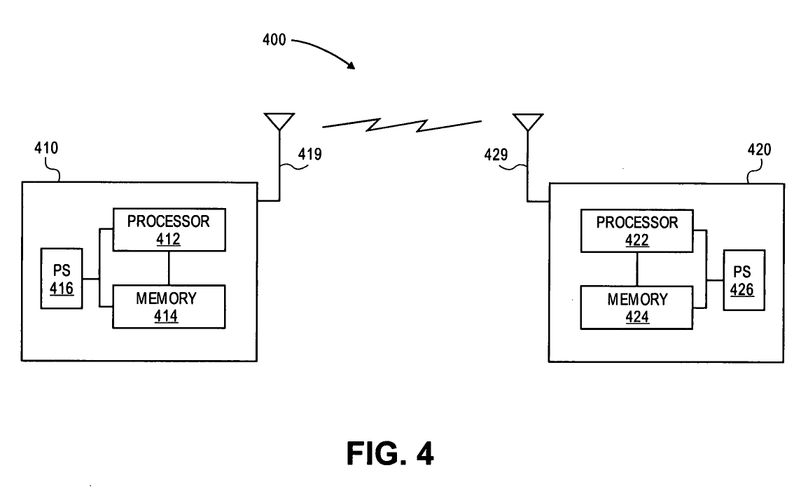

FIG. 4 shows a diagram of a communications system, according to an embodiment of the invention. In the illustrated embodiment, a wireless communications device 410 may transmit information to another wireless communications device 420, using the techniques described herein. Each device may have various components, such as but not limited to: at least one antenna (419, 429), at least one processor (412, 422), at least one memory (414, 424), and a power source (416, 426). In some embodiments the power source may comprise a battery, but in other embodiments the power source may use other techniques (e.g., a power supply to convert alternating current from a fixed source into direct current for powering the circuits of the device). In some embodiments the transmitting device may organize data segments for transmission in its memory, using the techniques described herein.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising
a wireless communications device to transmit a plurality of data segments in a single burst transmission, wherein the data segments are to be organized such that higher priority data segments are to be transmitted before lower priority data segments in the burst transmission.

2. The apparatus of claim 1, wherein each data segment is to comprise a protocol data unit.

3. The apparatus of claim 1, wherein each data segment is to comprise a length field to indicate a length of the data segment.

4. The apparatus of claim 1, wherein each data segment is to comprise a header portion and a data portion, the header portion to contain a length field to indicate a length of the data segment.

5. The apparatus of claim 1, wherein the higher and lower priorities are to be based on user application considerations.

6. The apparatus of claim 1, wherein the higher and lower priorities are to be based on network operational considerations.

7. The apparatus of claim 1, wherein a portion of the data segments are further to be organized into medium priority data segments to be transmitted in the burst transmission after the higher priority data segments and before the lower priority data segments.

8. A system, comprising:
an antenna; and
a wireless communications device coupled to the antenna to transmit first and second protocol data units (PDUs) sequentially in a burst transmission;
wherein each of the first and second PDUs is to include a length field to specify a length of the PDU; and
wherein one of the first and second PDUs is to be designated as higher priority and another of the first and second PDUs is to be designated as lower priority; and
wherein the higher priority PDU is to be transmitted in the burst transmission before the lower priority PDU.

9. The system of claim 8, wherein the wireless communications device is to perform said designation of the PDUs as higher and lower priority.

10. The system of claim 9, wherein said higher and lower priorities are to be pre-designated.

11. The system of claim 9, said higher priority and lower priority designations are based on time-critical considerations.

12. A method, comprising:
ordering a plurality of data segments for transmission, wherein each of the data segments includes a field indicating a length of the data segment; and
transmitting the plurality of data segments sequentially in a single wireless transmission, with higher priority data segments being transmitted before lower priority data segments.

13. The method of claim 12, wherein said transmitting a plurality of data segments comprises transmitting a plurality of protocol data units.

14. The method of claim 12, further comprising prioritizing the data segments prior to said transmitting.

15. The method of claim 14, wherein said prioritizing comprises prioritizing by groups.

16. The method of claim 14, wherein said prioritizing is based at least partially on a time-critical nature of data contained in the data segment.

17. An article comprising
a tangible machine-readable medium that contains instructions, which when executed by one or more processors result in performing operations comprising:
ordering a plurality of data segments for transmission, wherein each of the data segments includes a field specifying a length of the data segment; and
transmitting the plurality of data segments in a single burst transmission, with the data segments being transmitted in priority order from higher priority data segments to lower priority data segments.

18. The article of claim 17, wherein the operation of transmitting a plurality of data segments comprises transmitting a plurality of protocol data units.

19. The article of claim 17, further comprising an operation of prioritizing the data segments prior to said transmitting, said prioritizing based on an intended use of the data segments by a receiving device.

20. The article of claim 19, wherein the operation of prioritizing comprises prioritizing by groups.

21. The article of claim 19, wherein the operation of prioritizing is based at least partially on an anticipated usage of data contained in the data segment.
